(19) United States
(12) Patent Application Publication
(10) Pub. No.: US 2024/0426096 A1
(43) Pub. Date: Dec. 26, 2024

(54) UNIVERSAL MODULAR CONNECTOR

(71) Applicant: ANZ MODULAR LIMITED, Whangaparaoa (NZ)

(72) Inventor: Barry Warwick Ramsay, Matakatia (NZ)

(21) Appl. No.: 18/684,990

(22) PCT Filed: Aug. 19, 2022
(86) PCT No.: PCT/IB2022/057781

§ 371 Date: Feb. 20, 2024

(30) Foreign Application Priority Data
Aug. 20, 2021 (NZ) 779269

(51) Int. Cl. E04B 1/24

(52) U.S. Cl. CPC E04B 1/2403; E04B 2001/2406; E04B 2001/2415; E04B 2001/2418; E04B 2001/2427; E04B 2001/2466; E04B 2001/2484

(57) ABSTRACT

The invention relates to an accessible connector for a building module, the accessible connector comprising arms with a top plate and bottom plate, a cavity formed between the top plate and the bottom plate and having an open side, and fixing apertures formed in one of the plates to receive fasteners for engaging with a corresponding connector of a second building module. The fixing apertures are accessible through the open side of the cavity, which has a height containable within a module floor and/or ceiling envelope and sufficient to allow the insertion of fasteners through the open side.

### FIELD OF THE INVENTION

The present invention relates to a modular building construction. More particularly, but not exclusively, it relates to a modular connector suitable for use in fabricating and erecting modular steel frame constructions.

### BACKGROUND OF THE INVENTION

A modular building is a building constructed from a set of preferably standardised modules, a method of construction that has been seeing increasingly widespread use. Modules can be arranged in a grid and/or stacked on top of each other to construct buildings.

A typical module will be constructed using connectors in the lower and upper corners of the module, which are then connected together by beams, columns and optionally bracing as necessary. Joists may be inserted across the ceiling/floor of a module between opposite beams.

One method of modular building construction is to create completely enclosed modules having a floor, four walls and a ceiling. These modules can be constructed offsite and then transported to the site once complete and added into a building. This process is sometimes known as volumetric construction, and it can be highly efficient as the primary onsite construction processes becomes lifting the modules into place and fastening them together.

Accordingly, the connectors used in a modular building are some of the most important components, as they are subjected to high stresses by the attached structural elements of the building and are potential points of failure. Additionally, when adjacent modules are added, the connectors must align the modules with a high degree of accuracy in order to facilitate fastening the modules together. Furthermore, the potential need for a modular system to be suitable for seismic zones can be an additional factor.

One limitation of existing modular building systems is the strength of the connectors. Connectors are typically rated for buildings a fixed number of modules high, often limiting the height to considerably lower than what would be achievable using alternative construction techniques with comparable structural steel. Thus, it is desirable to find modular connector designs that optimise strength and allow for greater modular building heights, and/or provide suitability for construction in seismic zones.

An additional limitation may be the difficulty of properly fastening together adjacent modules. In addition to the difficulties involved in aligning the modular connectors, typical connector designs require cut-outs to be made in the building walls (interior or exterior) in order to provide access to the fasteners that will connect the lower connector of one module to the upper connector of an underlying module. Thus, it may be desirable to improve the ease of aligning the modular connectors and accessing the fasteners.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide a universal modular connector which overcomes or at least partially ameliorates some of the abovementioned disadvantages or which at least provides the public with a useful choice.

### BRIEF DESCRIPTION OF THE INVENTION

According to a first aspect the invention broadly comprises an accessible connector for a building module, the accessible connector comprising:
a first arm and a second arm extending at an angle from the first arm;
a top plate forming a top face of the first arm and the second arm;
a bottom plate forming a bottom face of the first arm and the second arm;
a cavity formed between the top plate and the bottom plate and having an open side;
a plurality of fixing apertures formed in either the top plate or the bottom plate and configured to receive a plurality of fasteners for engaging with a corresponding connector of a second building module, the fixing apertures being accessible through the open side of the cavity;
wherein the cavity has a height containable within a module floor and/or ceiling envelope and sufficient to allow the insertion of fasteners through the open side of the cavity.

According to another aspect, the fixing apertures are formed in the bottom plate such that they are configured to receive fasteners downwardly, the accessible connector is configured to be a lower connector of the building module, and the cavity is configured to be contained within the module floor envelope.

According to another aspect, the fixing apertures are formed in the top plate such that they are configured to receive fasteners upwardly, the accessible connector is configured to be an upper connector of the building module, and the cavity is configured to be contained within the module ceiling envelope.

According to another aspect, the accessible connector further comprises a pin aperture in the bottom plate configured to receive a pin of the corresponding connector of the second building module.

According to another aspect, the accessible connector further comprises a pin observation window on an outside face allowing visual confirmation of correct pin insertion into the pin aperture.

According to another aspect, the accessible connector further comprises a pin extending upwards from the top plate and configured to be received within a pin aperture of the corresponding connector of the second building module.

According to another aspect, the accessible connector is configured to be installed in the building module such that the open side of the cavity faces inwardly.

According to another aspect, the accessible connector is configured to be installed in the building module such that the open side of the cavity is made accessible by removing a floor panel of the building module or a ceiling panel of the second building module.

According to another aspect, the accessible connector is configured to be installed in the building module such that the open side of the cavity is made accessible by removing a ceiling panel of the building module or a floor panel of the second building module.

According to another aspect, a closed side of the cavity has one or more horizontal fixing apertures suitable for receiving fasteners to form horizontal connections with adjacent connectors.

According to another aspect, the second arm extends orthogonally from the first arm.

According to another aspect, the accessible connector further comprises one or more structural plates within the cavity that extend between the top plate and the bottom plate.

According to another aspect, the accessible connector further comprises two beam contact plates forming end faces of the first arm and the second arm, the beam contact plates being weldable to a beam selected from any of a set of standard beam types.

According to another aspect, one of the top plate or the bottom plate is weldable to a column and/or a diagonal brace each selected from any of a set of standard column types.

According to another aspect, the set of standard beam types includes the following:
Universal Beam (UB)
Square Hollow Section (SHS)
Rectangular Hollow Section (RHS)
Parallel Flange Channel (PFC)

According to another aspect, the set of standard column types includes the following:
Universal Column (UC)
Welded Column (WC)
Square Hollow Section (SHS)
Rectangular Hollow Section (RHS)

According to another aspect the invention broadly comprises a modular connector assembly connecting an above building module and an underlying building module, the connector assembly comprising:
an upper connector at an upper corner of the underlying module; and
a lower connector at a lower corner of the above module, wherein the lower connector is vertically adjacent the upper connector;
wherein one of the upper connector and the lower connector is an accessible connector comprising:
   a cavity having an open inner side and contained within the module floor and/or ceiling envelope; and
   a plurality of vertical fixing apertures within the cavity;
wherein the other of the upper connector and the lower connector is a corresponding connector comprising or containing a plurality of tightening components; and
wherein the above building module and the underlying building module are connected by a plurality of fasteners inserted into the fixing apertures via the open inner side of the cavity and bolted into the threaded columns of the receiving connector.

According to another aspect, the accessible connector is the lower connector and the corresponding connector is the upper connector, such that the fasteners are inserted downwardly.

According to another aspect, the accessible connector is the upper connector and the corresponding connector is the lower connector, such that the fasteners are inserted upwardly.

According to another aspect, the upper connector further comprises a pin extending upwards and received within a pin aperture of the lower connector of the above building module.

According to another aspect, the lower connector further comprises a pin observation window on an outside face allowing visual confirmation of correct pin insertion into the pin aperture.

According to another aspect, the corresponding connector also comprises a cavity having an open inner side.

According to another aspect, the tightening components are nuts inserted via the open inner side of the cavity of the corresponding connector.

According to another aspect, the tightening components are internally threaded vertical columns extending at least partway between upper and lower plates of the corresponding connector.

According to another aspect, the internally threaded vertical columns extend all the way between the upper and lower plates of the corresponding connector.

According to another aspect, the connector further comprises a gusset plate located between the receiving connector and the accessible connector, the gusset plate having gusset fixing apertures to allow passage of the fasteners.

According to another aspect, the gusset plate extends horizontally between two to four pairs of adjacent connectors, thereby connecting laterally or longitudinally adjacent building modules.

According to another aspect, further horizontal connections are formed between laterally or longitudinally adjacent connectors by fasteners inserted through horizontal fixing apertures in exterior sides of the adjacent connectors.

According to another aspect, the lower connector and the upper connector each have two orthogonal arms.

According to another aspect, the arms of the lower connector and the upper connector each have an end that presents a beam contact plate welded to a beam.

According to another aspect, the module floor and/or ceiling envelope is the space between a floor plane of the above module and a ceiling plane of the underlying module.

According to another aspect the invention broadly comprises a method of assembling a modular structure, the method comprising the following steps:
(a) Lifting an above building module into place atop an underlying building module, such that an upper corner of the underlying building module is aligned with a lower corner of the above building module and an accessible connector is aligned with and vertically adjacent to a corresponding connector;
(b) Accessing a cavity of the accessible connector via an open inner side of the cavity; and
(c) Inserting a plurality of fasteners into a plurality of fixing apertures within the cavity and engaging the fasteners into a plurality of tightening components within the corresponding connector.

According to another aspect, the accessible connector is a lower connector of the above building module and the corresponding connector is an upper connector of the underlying building module, such that the fasteners are inserted downwardly.

According to another aspect, the accessible connector is an upper connector of the underlying building module and the corresponding connector is a lower connector of the above building module, such that the fasteners are inserted upwardly.

According to another aspect, the corresponding connector comprises a cavity having an open inner side.

According to another aspect, the tightening components are nuts inserted via the open inner side of the cavity of the corresponding connector.

According to another aspect, the tightening components are internally threaded vertical columns extending at least partway between upper and lower plates of the corresponding connector.

According to another aspect, the modular structure comprises a plurality of underlying building modules, and step (a) is performed multiple times to place a plurality of above building modules.

According to another aspect, the modular structure comprises a plurality of aligned pairs of accessible connectors and corresponding connectors, and steps (b) and (c) are repeated to connect each aligned pair.

According to another aspect, before or as step (a) is performed a plurality of gusset plates are placed atop the underlying module such that they will be located in between the aligned pairs of accessible and corresponding connectors.

According to another aspect, some of the gusset plates are placed to connect between two to four underlying modules laterally or longitudinally.

According to another aspect, the method further comprises a step of forming further horizontal connections between laterally or longitudinally adjacent connectors by inserting and tightening fasteners through horizontal fixing apertures in the exterior sides of the adjacent connectors.

According to another aspect, for inserting and tightening fasteners, the horizontal fixing apertures are accessed via the open inner sides of the cavities of the adjacent connectors.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a perspective view of a modular structure;

FIG. 2 shows a perspective view of an upper connector in place in a module;

FIG. 3 shows a perspective view of the upper connector exterior side;

FIG. 4A shows a perspective view of the upper connector interior side;

FIG. 4B shows a cross-sectional side view of an upper connector with a nut and bolt configuration;

FIG. 4C shows a cross-sectional side view of the upper connector with a truncated column configuration;

FIG. 5 shows a perspective view of the lower connector in place in a module;

FIG. 6 shows a perspective view of the lower connector exterior side;

FIG. 7 shows a perspective view of the lower connector interior side;

FIG. 8A shows aperture placement in a first embodiment of a plate;

FIG. 8B shows aperture placement in a second embodiment of a plate;

FIG. 9 shows a perspective view of the lower connector interior side with fasteners, a beam and a column in place;

FIG. 10A shows a top view of a gusset plate with a line of symmetry;

FIG. 10B shows a top view of a gusset plate with a line of symmetry;

FIG. 10C shows a top view of a gusset plate with a line of symmetry;

FIG. 11 shows a top cross-sectional view of a modular structure with gusset plates visible;

FIG. 12 shows a perspective view of a modular connector assembly in place in a modular structure with a pin visible through a pin observation window;

FIG. 13A shows a perspective view of a modular connector assembly;

FIG. 13B shows a perspective view of a modular connector assembly with four modular connectors;

FIG. 14 shows a perspective cross-sectional view of a modular structure with the modular connector assembly visible;

FIG. 15 shows a perspective cross-sectional view of a module with a floor having a corner cut-out at the riser;

FIG. 16 shows a perspective cross-sectional view of a module with a floor having a removable panel at a corner;

FIG. 17 shows a side cross-sectional view of the lower connector and module floor envelope;

FIG. 18 shows a perspective view of a modular connector assembly with 180 degree arm angles and horizontal bolting;

FIG. 19A shows a perspective view of a pair of upper connectors with a horizontal bolt head visible; and

FIG. 19B shows a perspective view of a pair of upper connectors with horizontal nut visible.

### DETAILED DESCRIPTION OF PREFERRED EMBODIMENTS

The present invention is a modular connector system for modular structures. In particular, the connector is suitable for use (i.e. connection) with a large variety of common/standard beam, and/or column profiles.

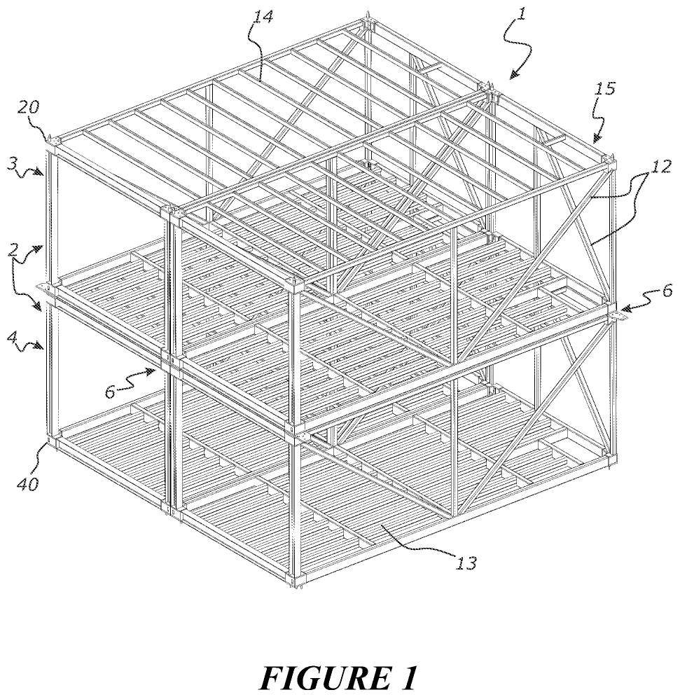

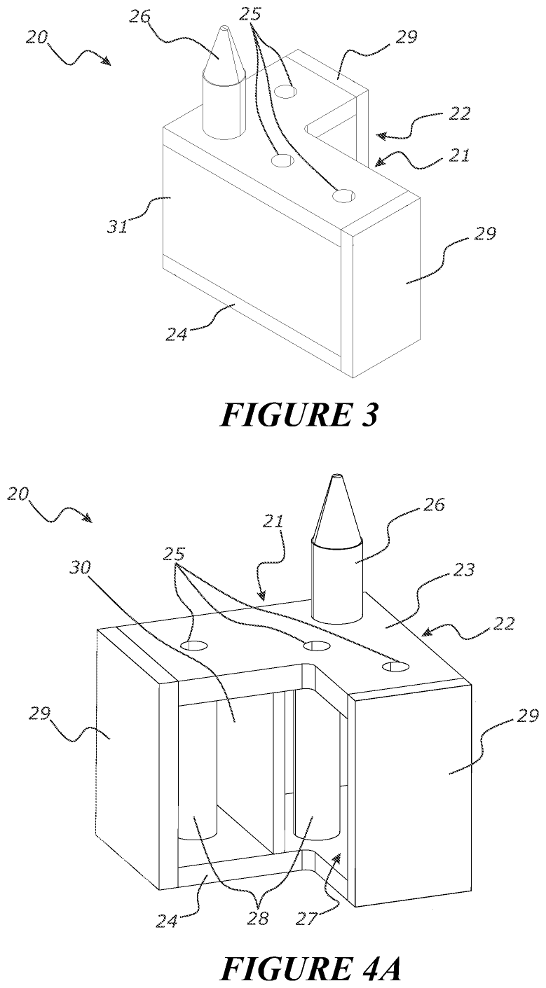

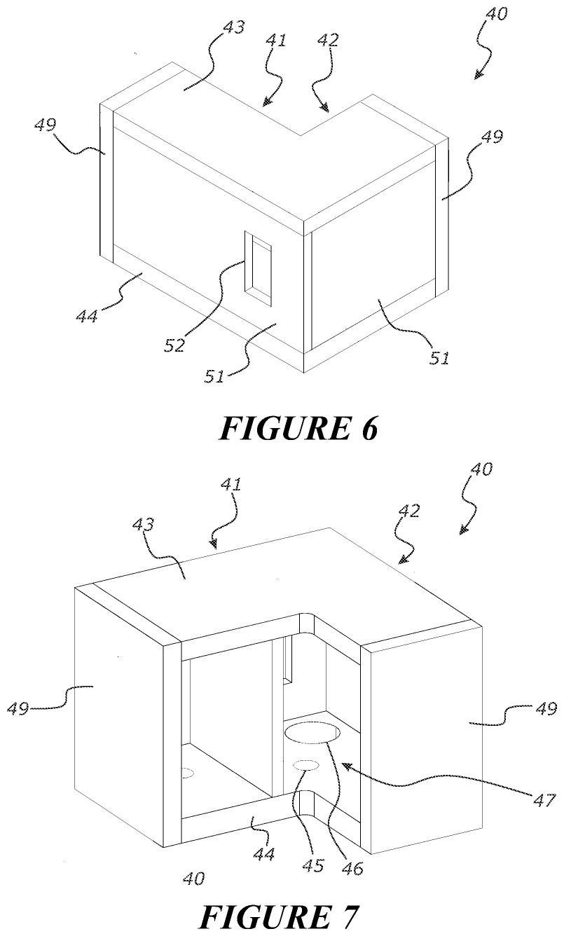

According to various aspects of the various embodiments of the present invention as illustrated in FIGS. 1-16, there is provided a modular connector 5 which will now be described.

As shown in FIG. 1, a modular structure 1 may comprise a plurality of building modules 2 which may be volumetric modules. The building modules 2 may be arranged in some combination of vertically, laterally or longitudinally adjoining modules 2. Preferably each building module 2 has a substantially cuboid volume and thus has four upper corners and four lower corners which are vertically and horizontally aligned.

The main structural elements of the building modules 2 may be a plurality of columns 10 at the vertical edges and beams 11 at the horizontal edges, preferably made from steel. There may additionally be diagonal braces 12 or vertical braces extending between the upper and lower horizontal edges of a module side to provide additional structural strength. Each corner of the module 2 preferably has a modular connector 5, which connects the column 10 and beams 11 of adjoining edges. The upper corners may each have an upper connector 20, while the lower corners may each have a lower connector 40. The modular connectors 5 may also be made from steel, or alternatively from another sufficiently strong material.

Building modules 2 may be of comparable size to shipping containers and transported in a similar manner. For example, they may be shipped via container ship, liftable by container cranes, and carried by a conventional truck and trailer. To this end, the building modules 2 are preferably compatible with at least some standardised hardware (e.g. that compatible with ISO standards for intermodal containers) for securing shipping containers during transport, for example various kinds of twistlocks. These could include bolted twistlocks bolted or welded of building modules 2, which may secure them to each other in a stacked configuration and/or in place within their transport vehicle. The modular connectors 5 may have features to facilitate such compatibility. Once transported to a building site, building modules 2 can be lifted into place by crane.

Where an above building module 3 is stacked on top of an underlying building module 4, each lower connector 40 of the above building module 3 and each upper connector 20 of the underlying building module 4 may form part of a modular connector assembly 6, preferably in combination with at least a gusset plate 60. Thus, a modular structure 1 may have a plurality of modular connector assemblies 6 located at corner junctions.

In alternative embodiments there may be additional modular connector assemblies 6 located in intermediate positions along the length of the beams 11, rather than only at the corner junctions. For example, a building module 2 may have intermediate connectors located in the middle of each of its longest beams 11, such that there are two or more additional modular connectors 5. Intermediate connectors in an upper beam would be upper connectors 20, while intermediate connectors in a lower beam may be lower connectors 40.

The present invention resides in the modular connector assembly 6 and more specifically in an accessible modular connector having both a cavity with an open side and fixing apertures within the cavity. The cavity can be contained within a module floor and/or ceiling envelope, such that the fixing apertures can be made accessible by removable floor or ceiling panels rather than by the alternative of a cut-out in the wall of the module 2. Two stacked building modules 2 can then be connected by inserting fasteners 48 through the accessible connector and engaging with tightening components 28 within a corresponding connector of the other building module 2, reducing the amount of disruption to the wall cladding during assembly. This allows the volumetric modules 2 to be more complete (i.e. when manufactured offsite), requiring less patch up work after assembly on site.

The module floor and/or ceiling envelope means, in a broad sense, the space between the plane of the floor 16 of an above module 3 and the plane of the ceiling of an underlying module 4. The height of this space will be approximately equal to the height of a modular connector assembly 6, i.e. that of two stacked modular connectors 5 plus any gusset plate 60. The present invention requires that the cavity of the accessible modular connector must be contained within this space, where normally it will be concealed until a floor or ceiling panel is removed to provide access to the open side. More specifically, ‘module floor and/or ceiling envelope’ may refer to the module floor envelope 17, which is the space in a single building module 2 underneath the plane of its floor 16, or to the module ceiling envelope, which is the space in a building module 2 above the plane of its ceiling. The cavity of the accessible modular connector must be contained in one of these spaces.

For clarity, throughout this specification ‘above module(s) 3’ means ‘module(s) that is/are above’. Likewise ‘underlying module(s) 4’ means ‘module(s) that is/are underlying’. Phrases including such language should not be misinterpreted as referencing some object that is above or below a module.

It will be appreciated that the accessible connector could be either an upper connector 20 (in the module ceiling envelope) or a lower connector 40 (in the module floor envelope) of a building module 2, and that the position of some features (in particular the tightening components 28) would depend on this. If the accessible connector is a lower connector 40, then the corresponding connector would be an upper connector 20 of an underlying building module 4 and the fasteners would be inserted downwardly. If the accessible connector is an upper connector 20, then the corresponding connector would be a lower connector 40 of an above building module 3 and the fasteners would be inserted upwardly.

Inserting the fasteners 48 downwardly may be advantageous due to gravity making the fasteners 48 easier to insert, and vibration being less likely to dislodge the fasteners 48. Upward insertion may be advantageous in specific circumstances, for example if a topmost building module 2 is connected via upper connectors 20 to roofing elements that would be difficult to access for downward insertion. A modular structure 1 may use some combination of modular connectors 5 configured for downward insertion and connectors configured for upward insertion. Because downward insertion is preferable, herein the accessible connector will be referred to as the lower connector 40 and the corresponding connector will be referred to as the upper connector 20 as is reflected by the figures. It will be appreciated that the reverse configuration is an alternative embodiment of the invention.

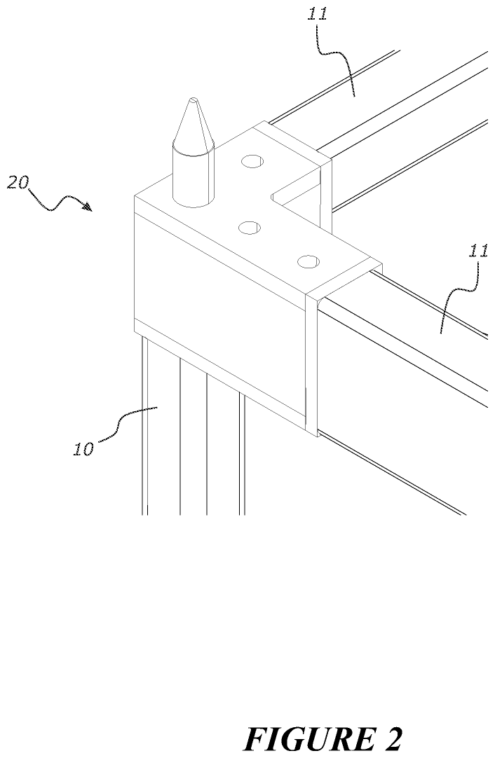

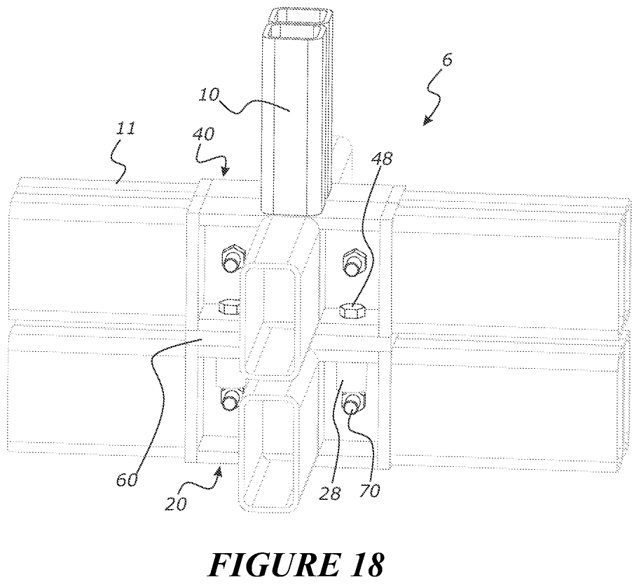

As shown in FIGS. 2-4A, an upper connector 20 comprises a first arm 21 and a second arm 22 extending at an angle from the first arm 21. The angle between the arms is preferably orthogonal in order to facilitate location of the upper connector 20 at an upper corner of a cuboid module 2, but alternatively it may be 180 degrees in order to facilitate use as an intermediate connector (as shown in FIG. 18) or it may be some other angle to facilitate use with an alternative module geometry. A top plate 23 may form a top face of the arms, while a bottom plate 24 may form a bottom face of the arms. Preferably the top plate 23 and the bottom plate 24 have a substantially identical profile.

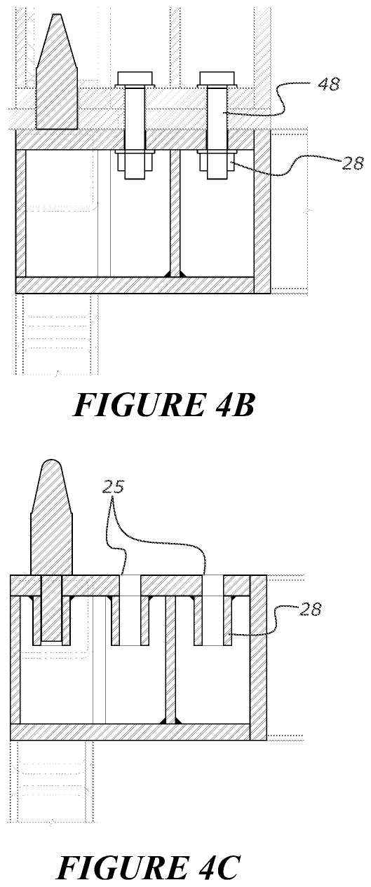

The upper connector 20 preferably contains or comprises the tightening components 28, with the top plate 23 having a plurality of fixing apertures 25 configured to receive fasteners 48. The tightening components 28 may be a plurality of internally threaded vertical columns descending at least partway from the fixing apertures 25 to the bottom plate 24 such that fasteners 48 can be bolted into the threaded columns. The columns form part of the upper connector and are rigidly connected to it. An embodiment with threaded columns descending all the way is shown in FIG. 4A, while an embodiment with threaded columns descending only partway is shown in FIG. 4C—the latter embodiment may be preferable due to reduced weight and cost of manufacture.

Alternatively, other types of tightening components 28 may be used, which may or may not be rigidly connected to the upper connector 20. For example, the tightening components 28 could instead be nuts used with each fastener 48 as shown in FIG. 4B, which may further reduce cost but could slightly increase the difficulty of installing fasteners 48.

In the alternative embodiment where the upper connector 20 is the accessible connector i.e. in the embodiment where the corresponding connector is configured to receive fasteners 48 upwardly, it will be appreciated that the tightening components 28 would instead be located in the lower connector 40.

The upper connector 20 may further comprise beam contact plates 29 forming end faces of the arms. Preferably the beam contact plates 29 are each of sufficient area to be welded to a beam 11. The bottom plate 24 preferably has sufficient area to be welded to a structural column 10. The top plate 23 and the bottom plate 24 may be separated by one or more vertical structural plates 30, which may include one or more backing plates 31 forming an exterior side of the upper connector 20. There may be a cavity 27 defined between the top plate 23 and the bottom plate 24, which may have an open inner side as shown in FIG. 4A. The exterior side is therefore preferably a closed side, but ‘closed’ is defined as encompassing the presence of apertures, windows or gaps in backing plates 31.

It will be appreciated that if the upper connector 20 is not the accessible connector and is rather the corresponding connector, the cavity 27 and its open inner side may not be necessary and the inner side could instead be closed. However, if access is required to engage the tightening components 28 (e.g. in the embodiment of FIG. 4B where nuts are used) then the cavity 27 and its open inner side must be present in addition to those of the accessible connector. If the upper connector is the accessible connector i.e. in the embodiment where the fasteners 48 are inserted upwardly, then a cavity and open inner side of the corresponding connector is likewise required for the insertion of fasteners 48.

The top plate 23 of upper connector 20 may present a vertical pin 26 configured to engage with the lower connector 40 of an above module 3. The pin 26 is preferably cylindrical with a conically tapered tip, but alternatively it may have another geometry suitable for engagement with a lower connector 40. The pin 26 may be permanently fixed to the upper connector 20, or may be removable, for example threaded into the connector 20.

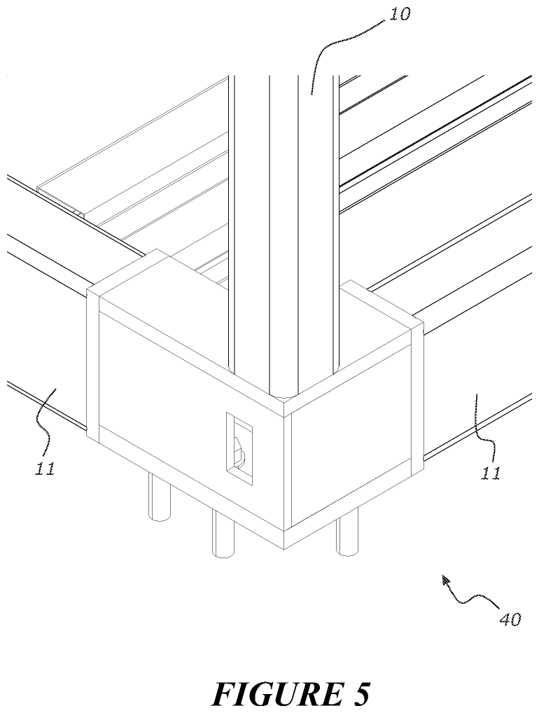

As shown in FIGS. 5-7, a lower connector 40 comprises a first arm 41 and a second arm 42 extending at an angle from the first arm 41. The angle between the arms is preferably a right angle in order to facilitate location of the lower connector 40 at a lower corner of a cuboid module 2, but alternatively it may be 180 degrees in order to facilitate use as an intermediate connector as shown in FIG. 18. Alternatively, it may be some other angle to facilitate use with an alternative module geometry, as desired. A top plate 43 may form a top face of the arms, while a bottom plate 44 may form a bottom face of the arms. Preferably the top plate 43 and the bottom plate 44 have a substantially similar or alternatively identical profile.

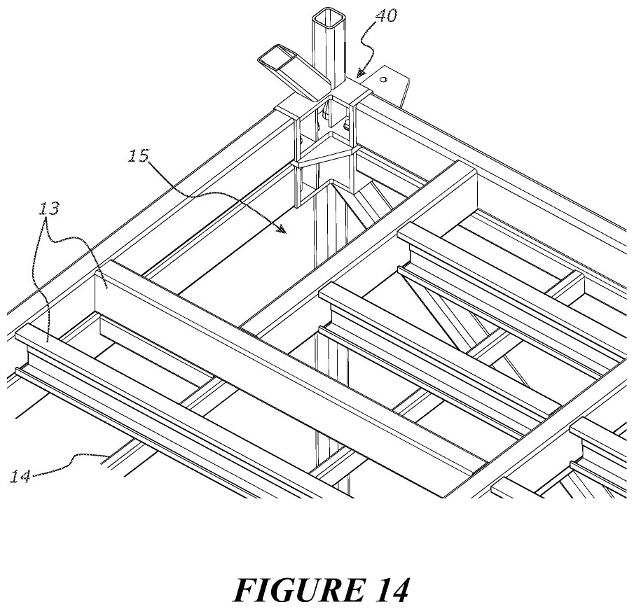

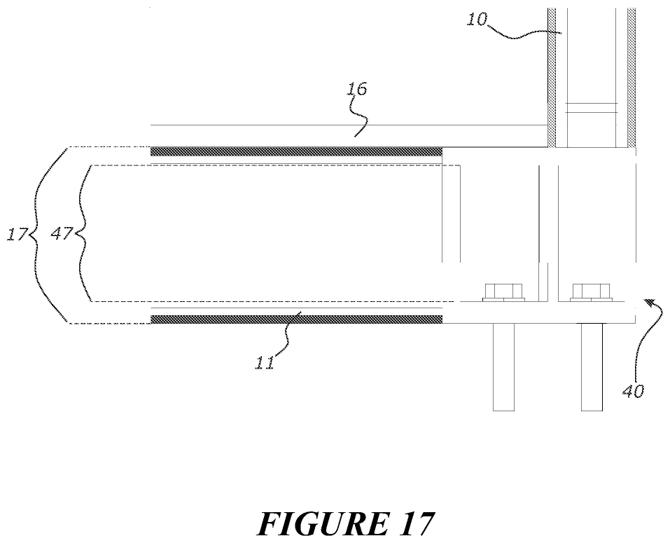

The bottom plate 43 has a plurality of fixing apertures 45 configured to receive fasteners 48. There is a cavity 47 defined between the top plate 43 and the bottom plate 44, which has an open inner side as shown in FIGS. 7 and 9. The cavity 47 has a height containable within a module floor and/or ceiling envelope, and more specifically a module floor envelope 17 as shown in FIGS. 14 and 17. The cavity 47 provides side access to the fixing apertures 45 through the open inner side, such that fasteners 48 can be brought into the cavity 47 and then pass through the fixing apertures 45 as shown in FIG. 9.

The height of cavity 47 and fasteners 48, as well as the size of the open inner side, may be configured to allow for the fasteners 48 to vertically fit in the cavity 47 with some clearance to facilitate insertion, wherein the fasteners 48 are sufficiently long to securely engage with an underlying upper connector 20. The cavity 47 is preferably also sufficiently sized to facilitate the use of typical tools for tightening the fasteners 48, for example torque wrenches or spanners. In addition to a cavity height requirement, such tools may require a minimum horizontal clearance between the fixing apertures 45 and the sides of the cavity 47.

In the alternative embodiment where the lower connector 40 is the corresponding connector i.e. configured to have fasteners 48 inserted upwardly, it will be appreciated that the tightening components 28 would be in the lower connector to receive fasteners 48 inserted via the open inner side of upper connector 20.

The lower connector 40 may further comprise beam contact plates 49 forming end faces of the arms. Preferably the beam contact plates 49 are each of sufficient area to be welded to a beam 11. The top plate 44 preferably has sufficient area to be welded to a column 10 as shown in FIG. 5. The top plate 43 and the bottom plate 44 may be separated by one or more vertical structural plates 50, which may include one or more backing plates 51 forming an exterior side of the lower connector 40. The exterior side is preferably a closed side, but ‘closed’ is defined as encompassing the presence of apertures, windows or gaps in backing plates 51.

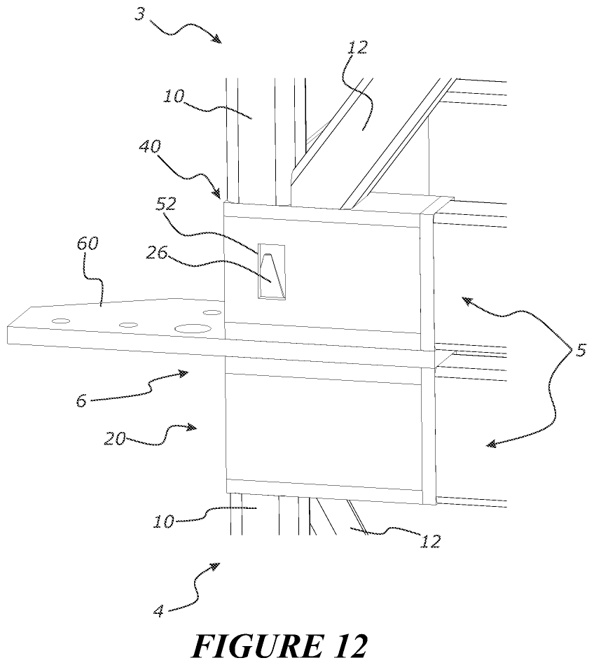

As shown in FIG. 12, the lower connector 40 may optionally further comprise a pin observation window 52 in an exterior side. The pin observation window 52 may allow visual inspection of the pin 26 of an underlying upper connector 20, facilitating confirmation that the pin 26 has correctly engaged with the pin aperture 46. The pin observation window 52 may be configured such that this confirmation can be made using a simple visual criteria, for example the pin observation may be located in a position where the tip of a correctly engaged pin 26 will align with the top edge of the pin observation window 46 when viewed side-on. This visual inspection may be done by personnel inspecting the outside of a modular structure 1 from temporary structures such as scaffolding, or by any other means of inspection.

The pin observation window 52 also provides a gripping point for the temporary installation of standard shipping container bridge fittings or twistlocks that allow the building modules 2 to be externally tied down during shipping or used to align the modules 2 during installation i.e. being able to pull down the above building module 3 into position on the below building module 4. These can also connect the modules externally horizontally.

As shown in FIGS. 1, 12 and 13A, a gusset plate 60 may be inserted between a below upper connector 20 and an above lower connector 40 when an above module 3 is stacked on top of an underlying module 4, thereby forming a modular connector assembly 6. As shown in FIGS. 1, 11 and 13B, the gusset plate 60 may extend between laterally adjacent modules 2 and serve as a connection means, and in a modular structure 1 there may be a gusset plate 60 at each junction of vertically, laterally and/or longitudinally adjacent module corners.

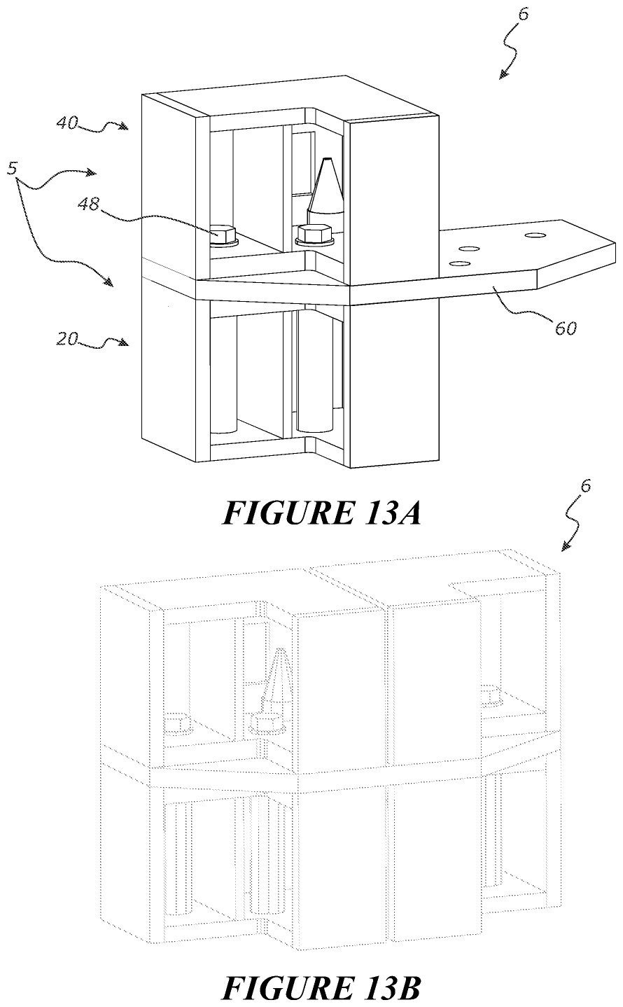

A modular connector assembly 6 could be formed from between two to eight modular connectors 5 on one gusset plate 60. FIG. 13B shows an example with four modular connectors 5, which would exist at a junction of four building modules 2 as shown in FIG. 1. If the modular structure 1 of FIG. 1 was repeated longitudinally and linked, there would exist one central junction of all eight building modules 2, for which a modular connector assembly 6 having eight connectors would be needed.

As shown in FIG. 18, a modular connector assembly 6 can also be formed with modular connectors 5 that are intermediate connectors having an arm angle of 180 degrees. In this arrangement, the limit to the number of connectors that can be on the same gusset plate 60 is four. Rather than being formed at corner junctions, these intermediate assemblies would be formed partway along adjacent beams 11 of adjacent building modules 2, for example at the halfway point. The intermediate connectors may have an additional and central beam contact plate 29, 49 to weld a cross-beam 11 to.

It will be appreciated that for modular connectors 5 having two arms at an angle, the possible angles in order of preference are:
a) 90 degrees, for standard corners
b) 180 degrees, for intermediate connectors
c) 270 degrees (i.e. with the open inner side on the other side compared to a 90-degree connector), for modules with an internally facing corner
d) Any other angle, possibly suitable for unconventional constructions.

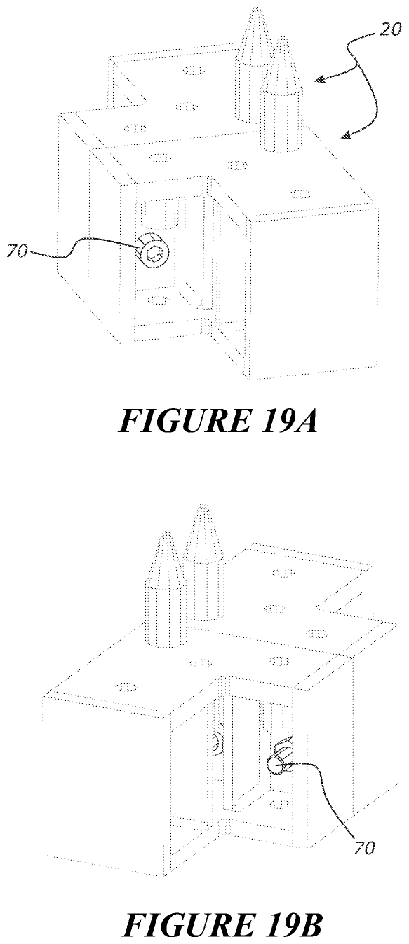

To provide additional connection strength to a modular connector assembly 6 with laterally or longitudinally adjacent modular connectors 5, further horizontal connections 70 may be formed between the modular connectors 5 by inserting fasteners. To facilitate this, appropriate horizontal fixing apertures may be provided in the closed exterior sides of the modular connectors 5 to receive the fasteners. FIG. 18 shows horizontal connections 70 made between adjacent walls of modular connectors 5 with 180-degree arm angles, while FIGS. 19A-19B show horizontal connections 70 made between those with 90-degree arm angles.

Preferably the fasteners are bolts, and the horizontal connections 70 are bolt and nut connections. Instead of nuts, the horizontal connections 70 may have an internally threaded sleeve on one side (attached to the closed side of one of the connectors) that receives the bolt and/or the horizontal fixing apertures themselves may be threaded. The fasteners could also be any other suitable type other than bolts, for example rods.

It will be appreciated that bolts are preferable for vertical fasteners 48 also, but any other type of fastener could be suitable in the same manner as described above.

It will be appreciated that in order for a horizontal connection 70 to be installed, access would be required via open inner sides of respective cavities 27, 47 of the modular connectors 5. In the embodiment where the tightening components 28 in the corresponding connector are threaded columns extending all the way from top to bottom, the columns might obstruct such access. Hence in FIGS. 18-19B the embodiment with only partially extending threaded columns is shown, however other embodiments such as bolt and nut connection would also be suitable. The ability to install horizontal connections 70 is a benefit of using cavities 27, 47 with an open inner side.

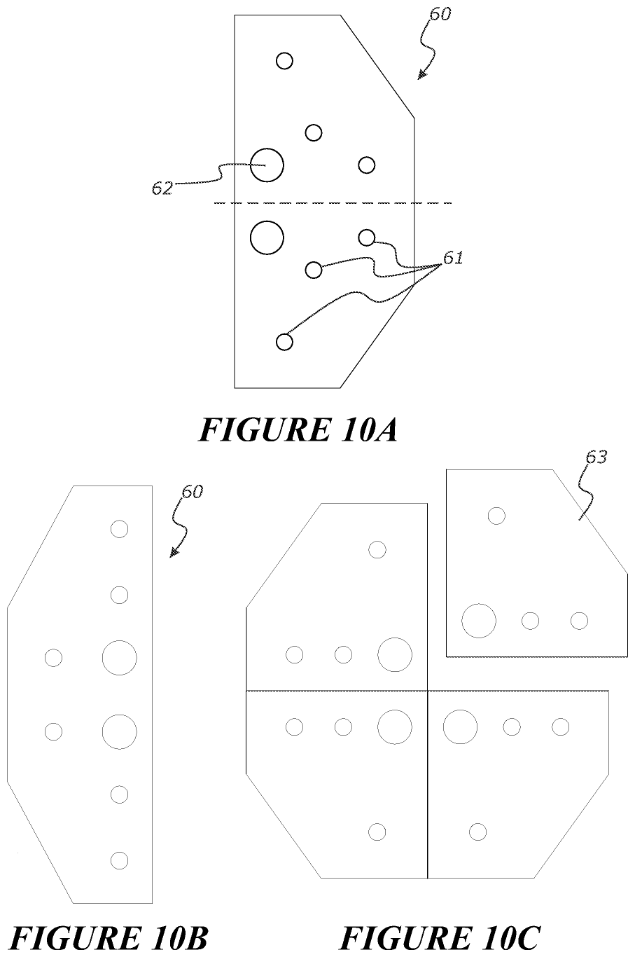

As shown in FIG. 10A, a gusset plate 60 has fixing apertures 61 configured to align with those of a below upper connector 20 and an above lower connector 40. The gusset plate 60 may additionally have at least one pin aperture 62 configured to align with the pin 26 of the below upper connector 20 and the pin aperture 46 of the above lower connector 40.

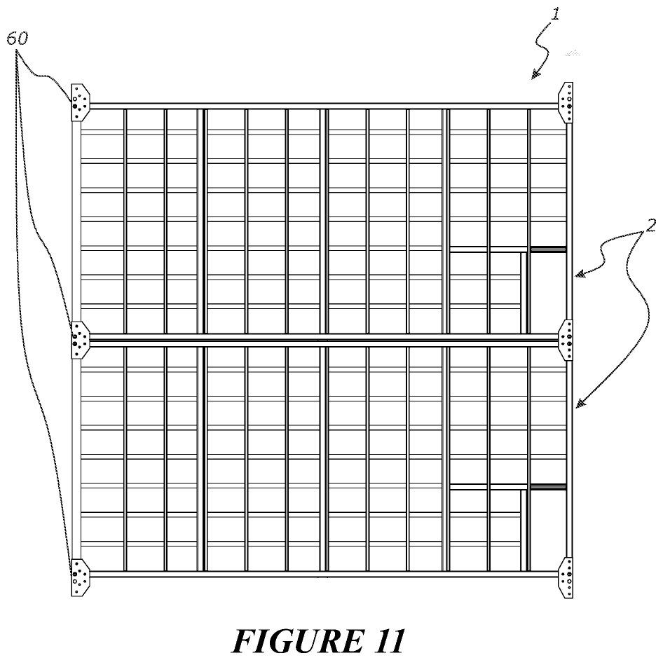

It will be appreciated that various sizes of gusset plates 60 are possible as are various placements of its fixing apertures 61. For example, FIG. 10B shows an embodiment of gusset plate 60 having slightly different shape and aperture placement, suitable for use with connectors that have a corresponding shape and aperture placement. A single modular structure 1 may use more than one embodiment of gusset plate 60, for example a first embodiment may be used at one end of each module 2 and a second variant may be used at the other end, as shown in FIG. 11.

As shown in FIG. 10C, a gusset plate 60 may comprise between one to four quarter units 63, each having its own set of apertures. A gusset plate 60 comprising only a single quarter unit 63 could be suitable for use at an outside wall of a modular structure 1, linking only a single pair of modular connectors 5. A gusset plate 60 having two quarter units 63 is shown in many of the figures and could be suitable for cross-linking modules 2 as shown in FIG. 11, thus connecting two pairs of modular connectors 5. Gusset plates having three or four quarter units 63 could additionally link modules 2 longitudinally, and thus link three or four pairs of modular connectors 5.

As shown in FIG. 18, the gusset plate 60 may be rectangular for use with modular connectors 5 having arm angles of 180 degrees.

Gusset plates 60 comprising two or four quarter units 63 are preferably symmetrical about a centreline, such that the sets of fixing apertures 61 and/or pin apertures 62 are mirrored about the centreline. A gusset plate comprising four quarter units 63 is preferably also symmetrical about an additional, orthogonal centreline. This means that the modular connectors 5 used on either side of the centreline(s) must also be of mirror-image shapes. It is possible however that one or more of the quarter units 63 could be of a different configuration instead of being symmetrical, which would allow different types of modular connectors 5 to be accommodated on one gusset plate 60. For example, one half of the gusset plate 60 might have the shape and layout of FIG. 10B, while the other half might be that of 10A or 10C.

It will be appreciated that gusset plates 60 of different sizes could be fabricated in various ways, for example by initially fabricating gusset plates 60 with two or four quarter units 63 and cutting them as needed to make smaller sizes, by having a separate process to fabricate each different size, or by welding together gusset plates with one or two quarter units 63 to make larger sizes. Gusset plates 60 can potentially be inserted with one size and then cut smaller at some stage of assembly of the modular structure 1.

Gusset plates 60 can also be used to connect the building modules 2 to different forms of construction such as concrete cores or other steel structures. This can be a welded or bolted connection.

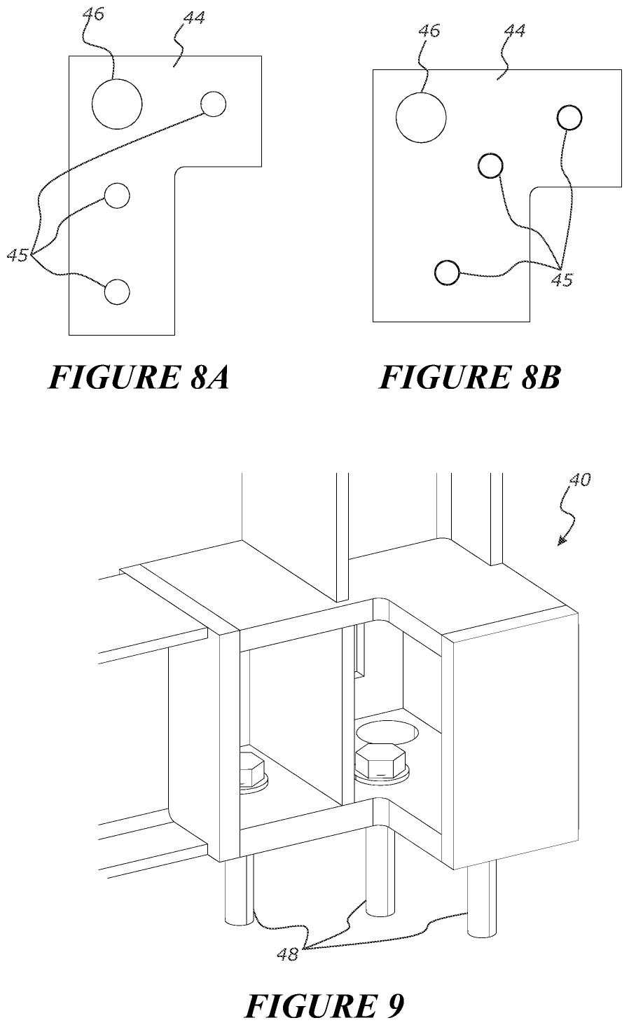

FIGS. 8A and 8B show different embodiments of the bottom plate 44 of the lower connector 40. The differences between the embodiments include variation in the profile and in the placement of the fixing apertures 45. It will be appreciated by a person skilled in the art that many variations of the profile are possible, however for a given lower connector 40 the top plate 43 preferably has a substantially similar or alternatively identical profile to the bottom plate 40. Similarly, the profile of vertically aligned modular connectors 5 in the same modular structure 1 is preferably substantially similar or identical.

It will furthermore be appreciated by a person skilled in the art that many variations in placement of the fixing apertures 45 are possible, but that within a modular connector assembly 5 the vertically aligned gusset plate 60 and upper connector top plate 23 must have substantially identical placement of their respective fixing apertures 61, 25 to allow alignment and insertion of fasteners 48.

A single modular structure 1 may contain more than one variation in the profile of its modular connectors 5. However, vertically aligned modular connectors 5 should preferably use the same variant. Furthermore, the configuration of modular connectors 5 for each module 2 should preferably be identical. For example, the corners of one longitudinal end face of a module 2 may use modular connectors 5 having a profile of a first type, while the corners of the other longitudinal end face of the module 2 may use modular connectors 5 having a profile of a second type. This is reflected in FIG. 1 wherein one end uses profiles of the type depicted in FIG. 8A, while the other end uses profiles of the type depicted in FIG. 8B. Use of such variants at different locations of a module 2 may provide structural or other benefits, for example allowing beams 11 of a different length or type to be utilised.

Beam contact plates 29, 49 may be configured to have sufficient area to be welded to a beam 11 selected from any of a set of standard beam types. Preferably the beam 11 is structural steel. This set of standard beam types may include:
Universal Beam (UB)
Square Hollow Section (SHS).
Rectangular Hollow Section (RHS)
Parallel Flange Channel (PFC)

Bottom plate 24 of the upper connector 20 and top plate 23 of the lower connector 40 may each be configured to have sufficient area to be welded to a column 10 selected from any of a set of standard column types. Preferably the column 10 is structural steel. This set of standard column types may include:
Universal Column (UC)
Welded Column (WC).
Square Hollow Section (SHS).
Rectangular Hollow Section (RHS)

In addition to having sufficient area for a column 10, bottom plate 24 of the upper connector 20 and top plate 43 of the lower connector 40 may additionally have sufficient area to be welded to a diagonal brace 12 as shown for example in FIGS. 1, 12 and 14-15. The diagonal brace 12 may extend between the bottom plate 24 of an upper connector 20 and the top plate 43 of a lower connector 40 in diagonally opposite corners of a wall plane of a module 2. The diagonal brace 12 may be selected from the same set of standard column types, but may have smaller dimensions than columns 10 and tapered ends facilitating connection at a diagonal.

The beam or column engaging plate elements may additionally be configured to have sufficient area to be welded to structural members within some specified range of dimensions. For example, the plate elements may have area sufficient to be welded to any beam or column within the respective set of standard types up to a maximum dimension or dimensions. To accommodate the requirements for different building projects, a variety of connector sizes can be manufactured which each have a different maximum structural member dimension. Thus, a large modular connector 5 might have a higher manufacturing cost but be able to accommodate the widest possible range of structural member dimensions.

The ability for the beam or column engaging plate elements to be welded to a variety of beam and column types may serve to make the modular connector 5 a universal modular connector in that it does not require modification of the design parameters to be used in a variety of applications. That is, on two different building projects utilising a modular structure 1, or on a single such project involving different types of structural metal, modular connectors 5 of the same specifications may be used. This may facilitate storage of modular connectors 5 in anticipation of future building projects, potentially including excess connectors manufactured for a building project where the excess might otherwise have had limited use. Alternative methods of engaging beams and columns such as a boss or cavity may be limited by their dimensions to a specific structural member, such that the connectors would be unsuitable for building projects outside of a narrow specification.

Modular connector assemblies 6 may be formed when an above building module 3 is stacked on top of an underlying building module 4 during construction of a modular structure 1. At this point in the construction process, each building module 2 has already been assembled, for example as part of a volumetric construction process, such that each modular connector 5 has been welded to the appropriate columns 10 and beams 11. The modular connector assembly 6 serves to connect complete adjacent modules 2.

At minimum, the process for connecting the above building module 3 and underlying building module 4 and by extension forming a modular connector assembly 6 includes the following steps:
(a) Lifting an above building module 3 into place atop an underlying building module 4, such that an upper connector 20 of the underlying building module 4 is aligned with a lower connector 40 of the above building module 3 (where one is the accessible connector and the other is the corresponding connector);
(b) Accessing a cavity of the accessible connector via an open inner side of the cavity; and
(c) Inserting fasteners 48 into fixing apertures within the cavity and engaging the fasteners 48 into the tightening components 28 within the corresponding connector.

It will be appreciated that in the embodiment of the above method where fasteners 48 are inserted downwardly i.e. where the lower connector 40 is the accessible connector, step (b) involves accessing a cavity 47 of the lower connector 40 via an open inner side of the cavity 47, and step (c) involves inserting fasteners 48 into fixing apertures 45 within the cavity 47 and engaging the fasteners 48 into the tightening components 28 of the upper connector 20. For upward insertion i.e. where the upper connector 20 is the accessible connector, the roles of the upper/lower connectors are reversed in these steps.

In greater length, the process for connecting modules 2 and by extension forming modular connector assemblies 6 may include the following steps:
i. Arranging a layer of laterally adjacent underlying modules 4;
ii. Placing gusset plates 60 on top of the upper connectors 20 of each underlying module 4, wherein each pair of adjacent upper corners is connected by a gusset plate 60;
iii. Lifting and placing a layer of laterally adjacent above modules 3 on top of the gusset plates 60 and the underlying modules 4;
iv. Inserting fasteners 48 via side access to the cavity of each accessible connector, passing the fasteners 48 through the fixing apertures 45, 61, 25 of the lower connector 40, gusset plate 60 and upper connector 20 respectively, and engaging them with the tightening components 28 of the corresponding connector.

Preferably step ii. of placing the gusset plates 60 is facilitated by the pins 26 of the upper connectors 20, as they serve to locate the gusset plates 60 via the pin apertures 62. Preferably the pins 26 further facilitate step iii. of placing the above modules 3, as the pins 26 serve to locate the lower connectors 40 via the pin apertures 46.

In the alternative embodiment where the upper connector 20 is the accessible connector such that the fasteners 48 are inserted upwardly, the pins 26 are preferably still presented upwardly by the upper connector 20 to facilitate placement in the same manner, which additionally allows each building module 2 to present a flat base that is convenient for storage and transport before placement.

Step iv. may be performed by personnel located within an above module 3 and reaching down into the module floor envelope 17 to access the cavity 27 and insert the fasteners 48, or alternatively by personnel located within an underlying module 4 and reaching up into the floor envelope 17 of the above module 3 to access the cavity 27 and insert the fasteners 48. Insertion from an above module 3 is preferred in order to minimise the distance personnel must reach to access the fixing apertures.

In the alternative embodiment where fasteners 48 are inserted upwardly, insertion from an underlying module 4 is preferred compared to insertion from an above building module 3.

Preferably personnel tighten the fasteners 48 using a suitable tool such as a torque wrench or spanner. A tool such as a torque wrench may be configured with electronics to record the torque applied to each bolt for logging purposes.

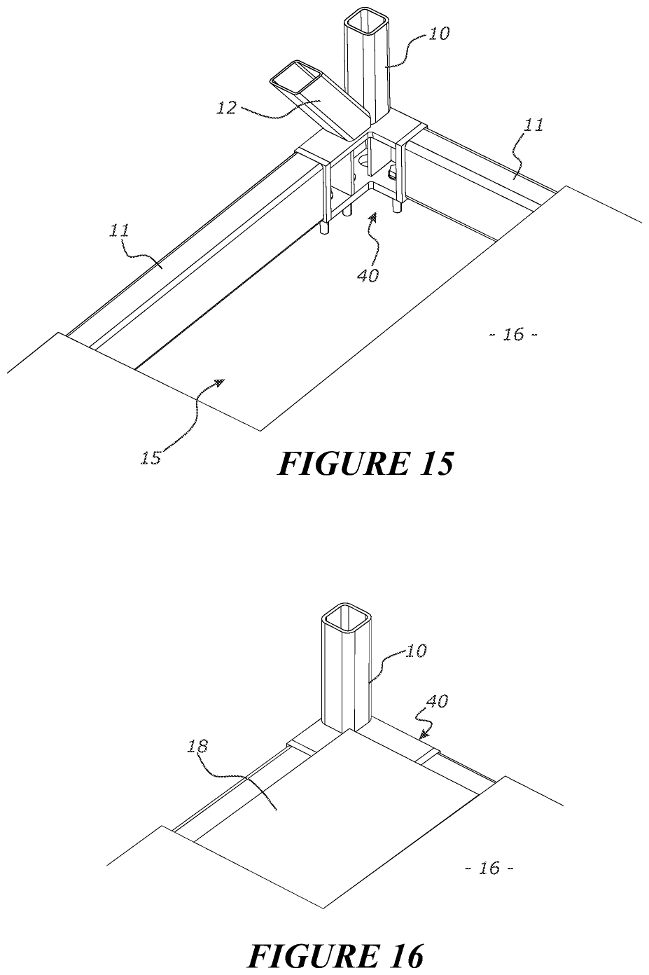

The construction process used to build modular structure 1 may be a volumetric construction process wherein the modules 2 already have walls, a ceiling and a floor 16 inserted before they are lifted into place in the modular structure 1. In this case the floor 16 may have removable panels 18 in at least some of the corners as shown in FIG. 16. Step iv. may therefore additionally involve temporary removal of the removable floor panels 18 to facilitate side access to each cavity 47 for insertion of fasteners 48, leaving the walls intact. As shown in FIGS. 14 and 15, modules 2 may have a riser 15 in one corner that creates a gap in the floor joists 13 and ceiling joists 14 in order to facilitate the running of conduits between vertically adjacent modules 2. A corner having a riser 15 may not have a removable floor panel 18 and may instead be permanently open, thereby still leaving the cavity 47 accessible and the walls intact.

Alternatively, the construction process used to build modular structure 1 may involve insertion of the ceiling and/or floor 16 after the modules 2 have been lifted into place. In this case step iv. can occur prior to or in conjunction with the insertion of the floor 16. Removable floor panels 18 may subsequently be inserted in at least some of the corners in order to facilitate future access to the fasteners 48 if necessary. Especially in commercial buildings, carpet and/or ceiling tiles are easy to install or replace once the module 2 is lifted into place and the fasteners 48 have been inserted, whereas wall cladding is preferably done offsite and is more difficult to fix later.

It will be appreciated that removable ceiling panels could be used instead of removable floor panels 18 to facilitate side access to the cavity 27 if insertion of fasteners 48 is to be done by personnel located in an underlying module 4.

The ability for fasteners 48 to be inserted from within the module floor envelope 17 may be advantageous compared to alternatives such as inserting the fasteners 48 from the top of the lower connector 40. If fasteners 48 were inserted from the top of lower connector 40 then they would have to be considerably longer and insertion would have to be done within the wall envelope, which would require a removable wall panel to facilitate access.

A removable floor panel 18 or a removable ceiling panel is preferable to a removable wall panel for several reasons. A removable floor panel 18 is easily concealed by carpet, which can be laid as a final step of construction after the building modules have been lifted into place. Carpet is easily lifted again if access to the fasteners 48 is required and can be placed again without difficulty. A removable wall panel cannot be as easily concealed, and its use may cause damage to the wall that will then be visible.

The increased length of fasteners 48 resulting from the use of a removable wall panel would induce less desirable structural loads to the fasteners 48, and increase the complexity of the connections.

A removable floor panel 18 also receives support from the underlying floor joists 13, whereas a removable wall panel may require additional fastening means to keep in place.

A removable ceiling panel can rest on ceiling joists and does not require concealment, and the entire ceiling may be formed from removable panels to facilitate access as is standard in many buildings.

A removable wall panel provides access to only the fasteners 48, because the rest of the modular connector 5 sits in the module floor envelope 17 and only the top is exposed. A removable floor panel 18 or ceiling panel can provide access to the entire modular connector assembly 6 rather than to just the fasteners 48, which may be useful for visual inspection purposes.

After an earthquake, each connection of a modular structure 1 must be checked to confirm the integrity of the modular connectors 5 and the fasteners 48. For a large structure this could involve the checking of hundreds of connections, so ensuring that they are easy to access and inspect is highly desirable. In some countries prone to earthquakes, for example New Zealand, building regulations may require this checking. Easy access offers building owners far greater certainty and better confidence in assessing the potential damage after such an event.

Preferably the plate elements of a modular connector 5, which may include top plate 23, 43, bottom plate 24, 44, beam contact plates 29, 49, structural plates 30, 40 and/or backing plates 31, 51, are discrete plate elements. Preferably the plate elements are connected together during fabrication by a process such as welding, but alternatively at least some of the plate elements may be connected together by means of fasteners such as bolts, or by slotted connections that may utilise an interference fit. The potential for the modular connector 5 to be assembled from discrete plates may significantly reduce manufacturing costs associated with casting complex parts.

One or more of the plate elements may alternatively be fabricated integrally with other plate elements, for example by a metal casting process, such that at least some of the plate elements are not discrete components but are instead different features of a single part. Casting may also be used to fabricate individual plate elements or other components before assembly.

To those skilled in the art to which the invention relates, many changes in construction and widely differing embodiments and applications of the invention will suggest themselves without departing from the scope of the invention as defined in the appended claims.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. An accessible connector for a volumetric building module, the accessible connector comprising:
a first arm and a second arm extending at an angle from the first arm;
a top plate forming a top face of the first arm and the second arm;
a bottom plate forming a bottom face of the first arm and the second arm;
two beam contact plates forming end faces of the first arm and the second arm, the beam contact plates being weldable to a beam selected from any of a set of standard beam types,
a cavity formed between the top plate and the bottom plate and having an open inner side configured to face inwardly when the accessible connector is installed in the building module;
a plurality of fixing apertures formed in either the top plate or the bottom plate and configured to receive a plurality of fasteners for engaging with a corresponding connector of a second building module, the fixing apertures being accessible through the open inner side of the cavity;
wherein the cavity has a height containable within a module floor and/or ceiling envelope and sufficient to allow the insertion of fasteners through the open inner side of the cavity, upon access through a removable panel in a floor or ceiling of the building module.

2. The accessible connector of claim 1, wherein the fixing apertures are formed in the bottom plate such that they are configured to receive fasteners downwardly, the accessible connector is configured to be a lower connector of the building module, and the cavity is configured to be contained within the module floor envelope.

3. The accessible connector of claim 1, wherein the fixing apertures are formed in the top plate such that they are configured to receive fasteners upwardly, the accessible connector is configured to be an upper connector of the building module, and the cavity is configured to be contained within the module ceiling envelope.

4. (canceled)

5. (canceled)

6. (canceled)

7. (canceled)

8. The accessible connector of claim 1, wherein the second arm extends orthogonally from the first arm.

9. (canceled)

10. The accessible connector of claim 1, wherein one of the top plate or the bottom plate is weldable to a column and/or a diagonal brace each selected from any of a set of standard column types, including:
Universal Column (UC)
Welded Column (WC)
Square Hollow Section (SHS)
Rectangular Hollow Section (RHS).

11. The accessible connector of claim 1, wherein the set of standard beam types includes the following:
Universal Beam (UB)
Square Hollow Section (SHS)
Rectangular Hollow Section (RHS)
Parallel Flange Channel (PFC)

12. (canceled)

13. A volumetric building module comprising:
a plurality of upper connectors and a plurality of lower connectors, wherein the upper connectors are accessible connectors according to claim 1 and the lower connectors are corresponding connectors, or vice versa;
a plurality of beams and columns at edges of the volumetric building module and connected by the upper connectors and the lower connectors; and
a floor, ceiling, and walls,
wherein the beams connect to the accessible connectors by being welded to the beam contact plates and the columns connect to the accessible connectors by being welded to the top plate or the bottom plate, and
wherein the beams and columns likewise connect to the corresponding connectors by being welded equivalently.

14. The volumetric building module of claim 13, wherein the floor has removable floor panels in at least some corners, or wherein the ceiling has removable ceiling panels in at least some corners.

15. (canceled)

16. (canceled)

17. (canceled)

18. A modular structure comprising:
an above volumetric building module and an underlying volumetric building module each with preinstalled floor, ceiling, and walls, and
removable panels in at least some corners of the floor of the above building module or the ceiling of the underlying building module,
wherein the above building module and the underlying building module are connected by connector assemblies each comprising:
an upper connector at an upper corner of the underlying module; and
a lower connector at a lower corner of the above module, wherein the lower connector is vertically adjacent the upper connector;
wherein one of the upper connector and the lower connector is an accessible connector comprising:
a cavity having an open inner side and contained within the module floor and/or ceiling envelope; and
a plurality of vertical fixing apertures within the cavity;
wherein the other of the upper connector and the lower connector is a corresponding connector comprising or containing a plurality of tightening components;
wherein each connector assembly further comprises a plurality of fasteners inserted into the fixing apertures via the open inner side of the cavity and bolted into the tightening components of the corresponding connector, and
wherein the lower connector and the upper connector each have two arms at an angle from one another and each having an end face formed by a beam contact plate welded to a beam.

19. The modular structure of claim 18, wherein the accessible connector is the lower connector and the corresponding connector is the upper connector, such that the fasteners are inserted downwardly.

20. (canceled)

21. The modular structure of claim 19, wherein the upper connector further comprises a pin extending upwards and received within a pin aperture of the lower connector of the above building module, and wherein the lower connector further comprises a pin observation window on an outside face allowing visual confirmation of correct pin insertion into the pin aperture.

22. (canceled)

23. The modular structure of claim 18, wherein the corresponding connector comprises a cavity having an open inner side.

24. (canceled)

25. The modular structure of claim 18, wherein the tightening components are internally threaded vertical columns extending at least partway between upper and lower plates of the corresponding connector.

26. (canceled)

27. The modular structure of claim 18, further comprising a gusset plate located between the receiving connector and the accessible connector, the gusset plate having gusset fixing apertures to allow passage of the fasteners, and wherein the gusset plate extends horizontally between two to four pairs of adjacent connectors, thereby connecting laterally or longitudinally adjacent building modules.

28. (canceled)

29. (canceled)

30. The connector assembly of claim 18, wherein the two arms of the lower connector and the upper connector are orthogonal.

31. The modular structure of claim 18, wherein the module floor and/or ceiling envelope is the space between a floor plane of the above module and a ceiling plane of the underlying module.

32. A method of assembling a modular structure, the method comprising the following steps:
(a) Assembling volumetric building modules using modular connectors by welding beams to beam contact plates forming end faces of arms of the modular connectors, welding columns to the modular connectors, and installing a floor, ceiling and walls in each volumetric building module, wherein the modular connectors include accessible connectors and corresponding connectors;
(b) Lifting an above volumetric building module into place atop an underlying volumetric building module, such that an upper corner of the underlying building module is aligned with a lower corner of the above building module and an accessible connector is aligned with and vertically adjacent to a corresponding connector;
(c) Accessing a cavity of the accessible connector via an open inner side of the cavity and through a removable panel in the floor or ceiling at the lower corner or the upper corner respectively; and
(d) Inserting a plurality of fasteners into a plurality of fixing apertures within the cavity and engaging the fasteners into a plurality of tightening components within the corresponding connector.

33. The method of claim 32, wherein the accessible connector is a lower connector of the above building module and the corresponding connector is an upper connector of the underlying building module, such that the fasteners are inserted downwardly.

34. (canceled)

35. The method of claim 32, wherein the corresponding connector also comprises a cavity having an open inner side.

36. (canceled)

37. (canceled)

38. The method of claim 32, wherein the modular structure comprises a plurality of underlying building modules, and step (b) is performed multiple times to place a plurality of above building modules.

39. The method of claim 32, wherein the modular structure comprises a plurality of aligned pairs of accessible connectors and corresponding connectors, and steps (c) and (d) are repeated to connect each aligned pair.

40. (canceled)

41. (canceled)

42. (canceled)

43. (canceled)
